(19) United States
(12) Patent Application Publication
(10) Pub. No.: US 2010/0153928 A1
(43) Pub. Date: Jun. 17, 2010

(54) Developing and Maintaining High Performance Network Services

(75) Inventors: Benjamin Livshits, Kirkland, WA (US); Emre M. Kiciman, Seattle, WA (US); Alexander C. Rasmussen, La Jolla, CA (US); Madanlal Musuvathi, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/335,799

(22) Filed: Dec. 16, 2008

(51) Int. Cl. G06F 9/44; G06F 15/177

(52) U.S. Cl. 717/132; 717/135; 709/220

(57) ABSTRACT

A network service runtime module executing on a processor is configured to accept a directed acyclic service graph representing elements of a network service application. During execution of the service graph, runtime events are stored. The service graph may by optimized by generating alternate service graphs, and simulating performance of the alternate service graphs in a simulator using the stored runtime events. A hill climber algorithm may be used in conjunction with the simulator to vary alternate service graphs and determine which alternate service graphs provide the greatest utility. Once determined, an alternate service graph with the greatest utility may be loaded into the network service runtime module for execution.

### BACKGROUND

High-performance network services are present in private, commercial, government, and other organizations. As used in this application, “network services” includes internet services as well as services available on other networks such as wireless wide area networks, telephone networks, local area networks, wide area networks, etc. These network services may provide interaction with management software, online transactions, or access to government programs. Developing and maintaining high-performance network services is highly demanding of developers and system administrators. While a common conceptual model describes a network service as a single pipe which takes user input and outputs a result, the actual development of a network service is far more complicated.

The complexity regarding development of high-performance network services results, in part, from the array of components used to implement and deploy the network service and their interactions. An otherwise simple service may find itself executing in a complicated environment. This environment may encompass a cluster of servers, each server having variable reliability and performance characteristics, responding to a dynamically changing, large-scale real-world load.

Development of network services that operate with high-performance and reliability take into account this range of environmental factors through careful planning and design of complex software, hardware and network architectures and infrastructure. This planning is time consuming, difficult, and ultimately results in a network service based upon a static assessment of the environment. An undesirable development choice regarding the environment may result in a system which is inoperative, slow, or prone to failures. Furthermore, modifying the network service after deployment to adapt to a change in the environment or to further optimize the network service may be expensive and challenging given the intricate implications of environmental factors and the complexity of the architectures and infrastructures of the service.

### SUMMARY

As described above, development and optimization of a network service is complicated and time intensive. To provide an optimized and high performance network service, developers and administrators must take into account a variety of factors in a complicated and dynamic environment. Furthermore, changes in traffic over time may necessitate varying the configuration to maintain optimal responses to end users.

This application describes a method of developing network service applications without detailed consideration by a developer as to the environmental implications, such as the implications of workload distributions, on the service architecture and infrastructure. The application also describes ways to automate optimization of existing network services. A directed acyclic service graph describing components of the network service may be used to build a network service. A service graph may also be generated by analyzing an existing network service. During execution of the network service in a network service runtime module, runtime events are stored, and provided to an optimizer module. The optimizer module simulates variations on the service graph including, for example, different cache policies. In that case, during cache policy simulation, the optimizer module uses a hill climber algorithm or other algorithm to find optimal cache policies. The network service runtime module may then incorporate the optimal cache policies.

### BRIEF DESCRIPTION OF THE DRAWINGS

The disclosure is made with reference to the accompanying figures. In the figures, the left most digit of each reference number identifies the figure in which the reference number first appears. The use of the same reference numbers in different figures indicates similar or identical terms.

FIG. 1 is a diagram of an illustrative network environment incorporating a service graph, a network service runtime module, and an optimizer module.

FIG. 2 is a diagram illustrating factors which may affect a network service developer during the development process.

FIG. 3 is a diagram of an illustrative simplified development process.

FIG. 4 is a diagram of an illustrative path followed by a user request through several servers across multiple data centers according to an implementation.

FIG. 5 is a diagram of illustrative elements which may comprise a service graph.

FIG. 6 is a diagram of an illustrative service graph depicting a network service distributed across multiple servers and data centers according to an implementation.

FIG. 7 is a diagram of an illustrative service graph depicting the service graph of FIG. 6 modified to include a cache.

FIG. 8 is a diagram of an illustrative service graph depicting a flow of data through a service graph which returns a weather forecast based on a zip code input.

FIG. 9 is a diagram depicting possible cache locations for the illustrative service graph of FIG. 8.

FIG. 10 is a diagram of an illustrative optimizer module.

FIG. 11 is a flow diagram of operation of an illustrative optimizer module.

FIG. 12 is a flow diagram of an illustrative process of building and optimizing a service graph.

FIG. 13 is a flow diagram of an illustrative process of analyzing an existing network service, building a service graph, and providing optimization recommendations.

### DETAILED DESCRIPTION

Development of network services involves taking into account a wide range of factors, which is time consuming, difficult, and ultimately results in a network service based upon a static assessment of the environment by the developer. This application describes a method of developing network service applications without detailed consideration by a developer as to underlying infrastructure, as well as the optimization of network services. While this disclosure is described in terms of a network service application, the teachings are also applicable to development and optimization of other applications as well.

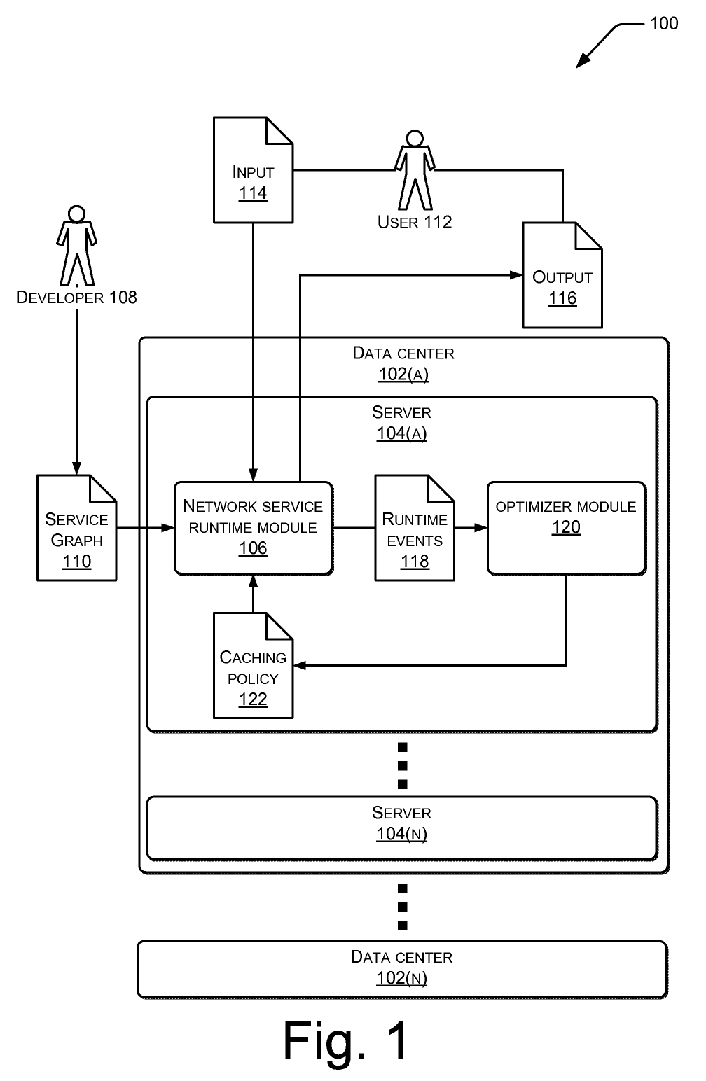

FIG. 1 a schematic of an illustrative network environment 100. One or more data centers 102(A) through 102(N) are present in network environment 100. As used in conjunction with the reference numbers of this application, “N” is any integer number greater than zero. Within a data center 102, one or more servers 104(A) through 104(N) may be present. Within server 104, a network service runtime module 106 may be present. This network service runtime module 106 executes network services on one or more processors using instructions stored in one or more computer-readable storage mediums, such as random access memory, flash memory, magnetic storage, optical storage, etc.

A developer 108 may have an idea for a network service. Developer 108 produces a service graph 110, discussed in more detail below, which describes the network service. This graph may be a directed acyclic graph (DAG), that is, connections (edges) between components in the graph have a particular direction and do not form a loop. In one implementation, components in the graph may represent either application level components or high-level control flow statements while connections (edges) within the graph represent dataflow. Service graph 110 is then loaded into network service runtime module 106 for execution.

A user 112 may provide input 114 to the network service runtime module 106. For example, the user 112 may click a button on a webpage, enter text for a search, etc. The network service runtime module 106 may then produce an output 116 which may be presented to user 112, via a webpage, email, text message, etc.

During execution, the network service runtime module 106 outputs runtime events 118. These runtime events comprise session information indicating what session the event is associated with, a traversed edge (i.e., a path taken among the components), a time at which the event took place, a datum such as size, among others.

The runtime events 118 are then processed by an optimizer module 120. The optimizer module 120 takes runtime events, simulates them, updates a simulation state using a hill climber algorithm, and produces an optimized caching policy 122. While optimized caching policies are described in this application, optimization may additionally or alternatively comprise changing a service graph layout, replacing or swapping a component or other element for an alternate component or element to improve overall performance, etc. The optimized caching policy may then be input to the network service runtime module 106 for execution. The change from the service graph 110 to an optimized service graph incorporating the optimized caching policy 122 may be made while the network service runtime module is handling transactions (online) or when the network service runtime module is quiescent (offline).

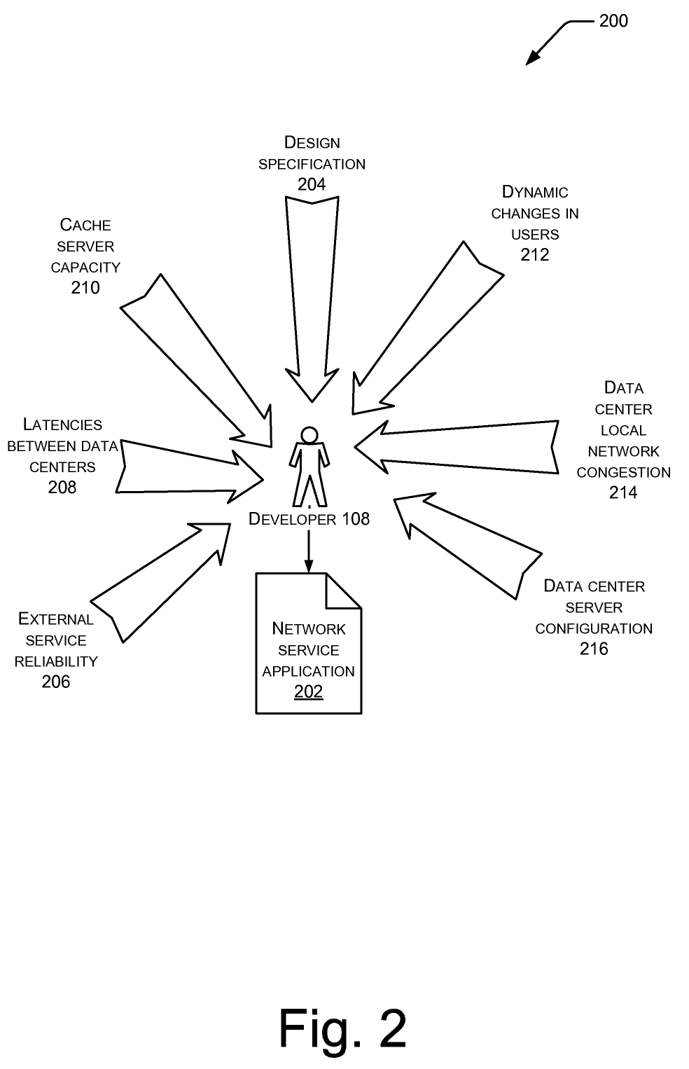

FIG. 2 illustrates factors 200 which may affect a network service developer during the development process. In developing a network service application 202, a developer 108 has many factors to consider. These include a design specification 204, which defines the functionality the developer is trying to achieve. Reliability of an external service 206 called upon by the network service application 202 is a factor. Latencies between datacenters 208 require consideration. Cache server capacity 210 is factored in. Dynamic changes in users 212 of the service take place. For example, changes in traffic patterns due to changing demographics or varying interests of end users. Additionally, local network congestion within data centers 214 may affect performance. Configurations of the servers in a data center 216 as well as the data centers themselves also affect performance. Production of a functional, much less an optimized, network service thus requires consideration of these and many more dynamic factors by the developer 108 to produce network service application 202. It is unrealistic to think that the developer 108 will be able anticipate how all of these factors will interact and change, and to develop a network service well optimized for these interactions.

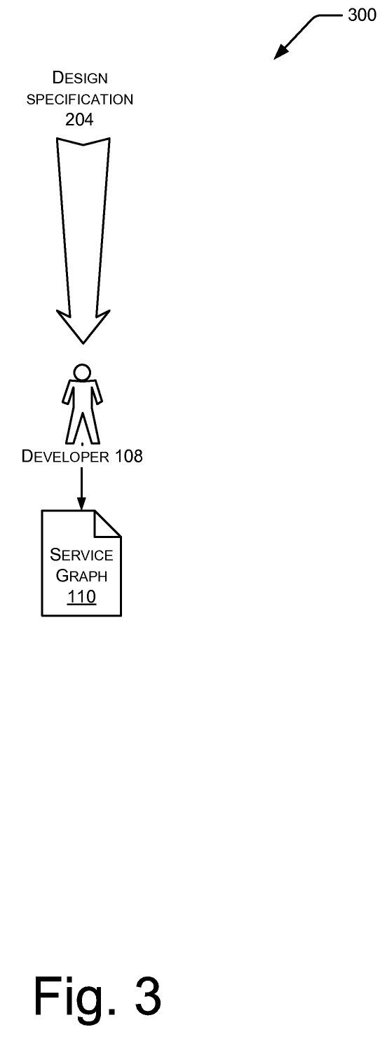

FIG. 3 illustrates a simplified development process 300 disclosed by this application. At 300, the developer 108 considers the functional design specification 204, and builds the service graph 110. By using the service graph and optimization methods described below, the developer 108 is freed from consideration of at least the multitude of factors shown in FIG. 2.

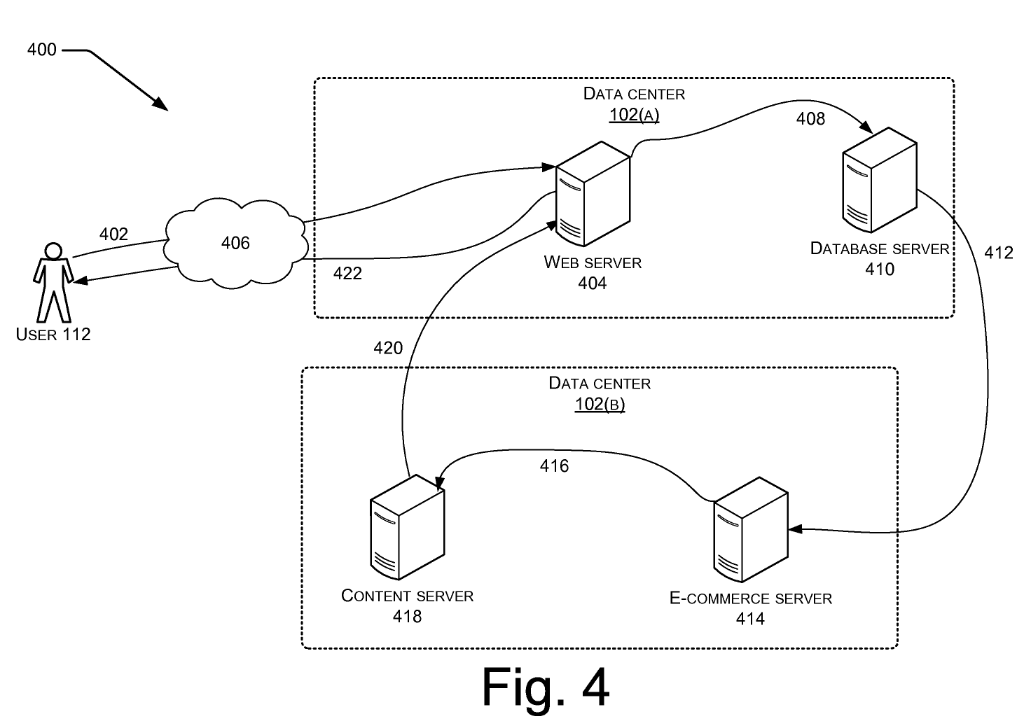

FIG. 4 illustrates a path 400 followed by a request of a user of the network service through several servers across multiple data centers. For example, in this illustration, user 112 may make a request 402 of a web page hosted on web server 404 via a network 406. The network 406 may comprise the internet, a cable television network, a wireless network, a local area network, etc. This request may be to purchase and/or access digital content, such as a movie, e-book, game, etc. In order to fulfill the request, web server 404 sends a query 408 to database server 410 via a data link, to validate if the user 112 has a valid account. Web server 404 and database server 410 may be physically located in data center 102(A) or may be communicatively coupled to the data center 102(A).

After validating the user account, database server 410 sends a payment validation request 412 via a data link to e-commerce server 414 to validate payment. E-commerce server 414 validates payment, then sends an approval 416 to provide content to content server 418 via a data link. Content server 418 then provides content 420 to web server 404 via a data link, which then serves content 422 to user 112 via the network 406. Content server 416 and e-commerce server 412 are physically located in data center 102(B) in this illustration.

In this simple example, a single user request has accessed several components located across four servers and two data centers. To conventionally build the network service and optimize performance for even this simple application calls for consideration by the developer of these factors. Factors which may comprise the multiple servers, data links, different data center environments in this example, as well as those factors described above in FIG. 2. A service graph provides a method of building and optimizing the network service without a developer actively considering these factors.

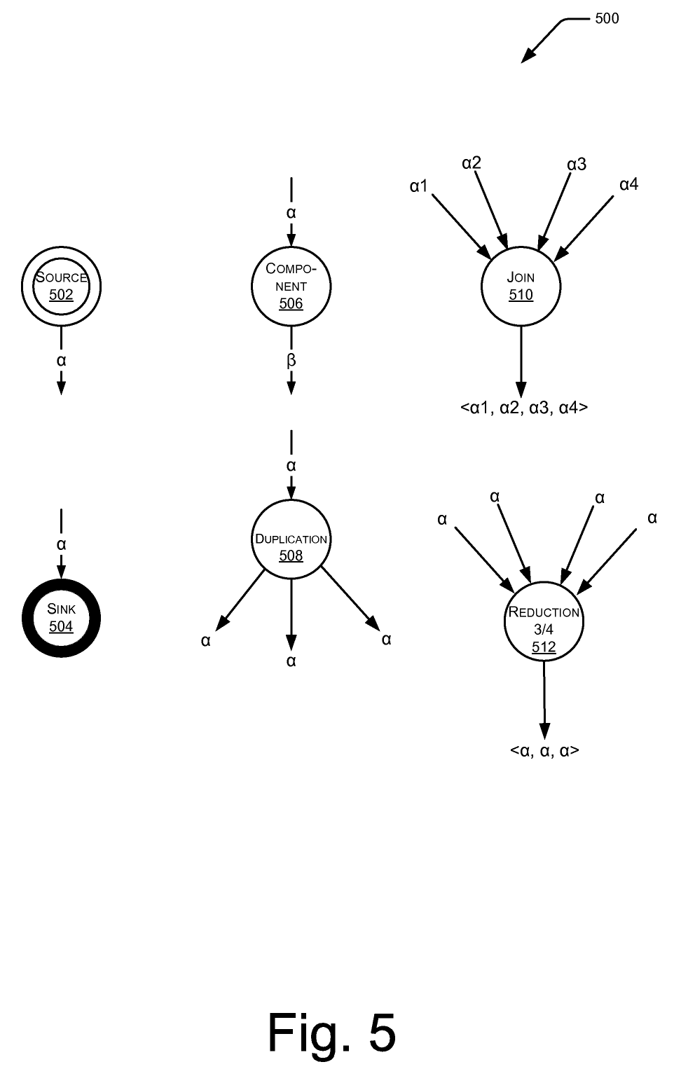

FIG. 5 illustrates elements which may comprise a service graph 500. As described above, this service graph model is a directed acyclic graph. Each service graph comprises a dedicated source node 502 which emits an output and a dedicated sink node 504 which accepts an input. A piece of data thus travels through the service graph from a source and a sink along edges, also known as links or paths. A component element 506 (component) may take an input and emit an output. A duplication element 508 takes an input and emits multiple copies of the input along new edges. A join element 510 accepts multiple inputs and emits a single output comprising the set of those inputs. A reduction element 512 takes multiple inputs and returns a subset of those inputs. While the join element 510 must wait for all of its multiple inputs to arrive before it may emit an output, the reduction element 512 may emit an output as soon enough inputs have arrived to fill the required subset. For example, a ¾ reduction would take four identical inputs and emit an output containing the first three inputs to arrive at the reduction element. The service graph is type-safe, such that whenever there is a flow of a piece of data between components, a sub-typing relationship holds. Type-safety aids analysis of program behavior and automatic manipulation of the service graph. For example, in a type-safe graph caches may be added and/or components moved without introducing new data types. A component or element in the service graph may also be considered a node. In another implementation, strong type-safety may be used, for example, during production of more efficient specialized code from the service graph.

Each element may comprise a staleness-parameter delta (Δ). This staleness-parameter may be used when a component computes some function of its input that may change over time. For example, a component processing weather information may use the staleness-parameter to indicate when an output from that element is possibly stale. The possibly-stale return value of a component is given by

fΔ(t,x) (Equation 1)

and satisfies the following staleness-condition

∀t,x fΔ(t,x)=f(t′,x)f or some t′,t−Δ≦t′≦t. (Equation 2)

Assume that Δ is several orders of magnitude larger than the time to compute f itself. Thus, when reasoning about staleness of components, it may be assumed that all components produce their results instantaneously. Also, the component is allowed “perfect freedom” in choosing a return value, within the bounds of its staleness condition. “Perfect freedom” indicates that the component is not otherwise restricted from choosing a return value. The staleness-condition does not guarantee any correlation between different components and for different inputs to the same component. For example, in a component which returns weather information, it is valid for weather in city A to be stale while the weather in city B is not.

A cache may be introduced around a sub-graph (e.g., one or more nodes in the graph). The service graph method may ensure that the cached values satisfy the staleness-condition for every node in the sub-graph. In particular, when introducing a cache around component f followed by a component g, the method may ensure that

∀t,x(gΔ,f_{c})=g(t_{1,}f(t₂,x)) (Equation 3)

where t−Δ≦t₁ and t−ε≦t₂≦t.

A service graph thus comprises a collection of these elements, joined by edges indicating data flow. Thus, a user may create a service graph describing a network application.

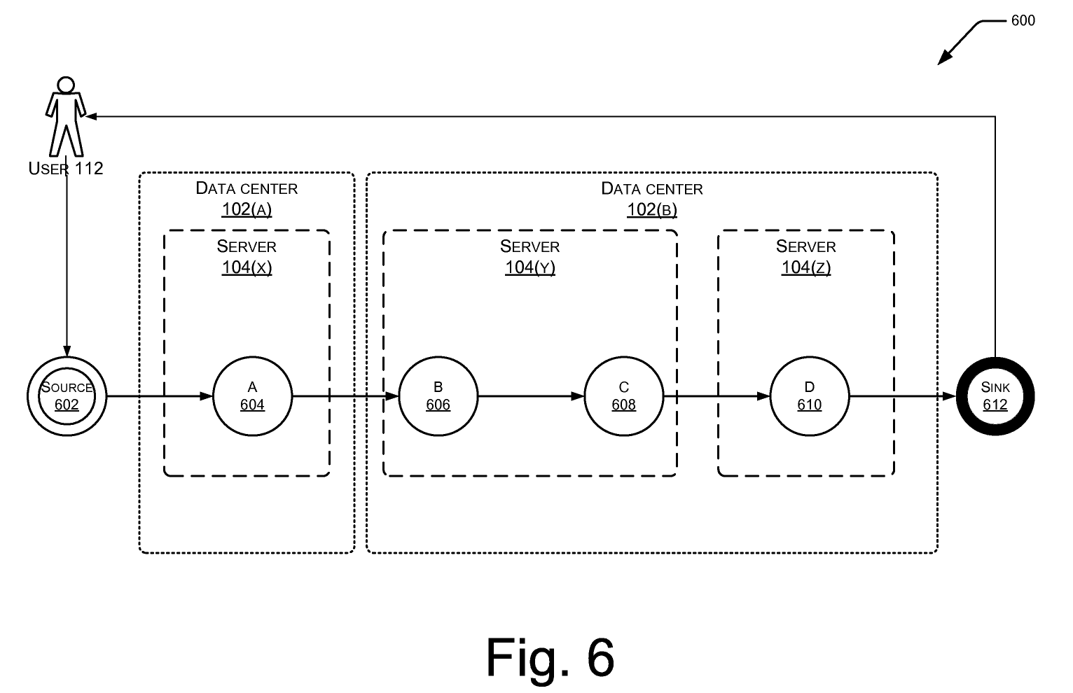

FIG. 6 is an illustrative service graph 600 depicting a network service distributed across multiple servers and data centers. Source 602 is connected to component A 604, which connects to component B 606, which connects to component C 608, which connects to component D 610, which connects to sink 612. A user may provide input into source 602 and receive output from sink 612.

Component A 604 resides on server 104(X) within data center 102(A). Components B 606 and C 608 reside on server 104(Y) within data center 102(B). Component D resides on server 104(Z) and is also within data center 102(B). In this and the following illustrations, broken lines indicate physical locations of elements within particular data centers and servers. However, placement of elements within particular physical locations is illustrative, and is not necessarily part of the service graph.

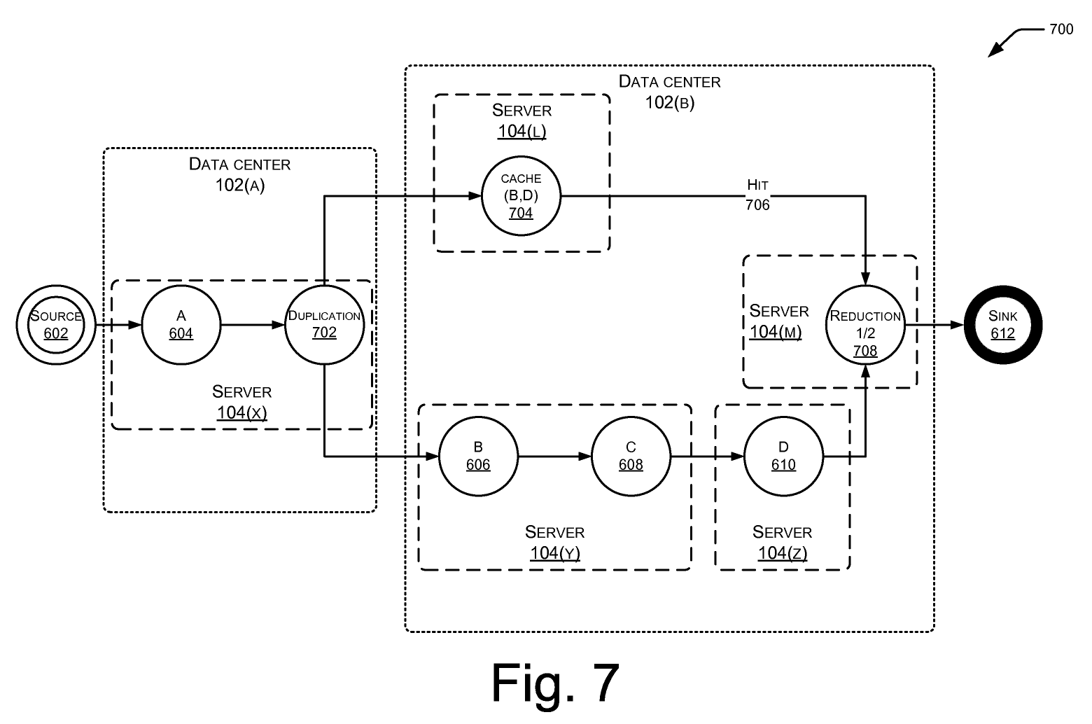

FIG. 7 is an illustrative service graph 700 depicting the service graph of FIG. 6 modified to include a cache 704. For example, assume that it is determined a cache for components B 606 and C 608 would be beneficial. The cache 704 encompasses components B 606, C 608, and D 610, and is designated Cache(B,D). The revised service graph incorporating Cache(B,D) is configured as follows.

Source 602 connects to component A 604, which connects to a duplication element 702. In this illustration, both component A 604 and duplication element 702 reside on server 104(X) within data center 102(A), as indicated by broken lines. Duplication element 702 in turn connects to two components within data center 102(B): component Cache(B,D) 704 located on server 104(L) and component B 606 located on server 104(Y). Component B 606 connects to component C 608, which also resides on server 104(Y). Component C 608 connects to component D 610, which resides on server 104(Z). Component Cache(B,D) 704 and component D 610 connect to reduction element 708, which resides on server 104(M) within data center 102(B). Reduction element 708 receives input and emits an output to sink 612. The output of reduction element 708 may be, for example, a first result presented by either Cache(B,D) 704 or component D 610, or reduction element 708 may otherwise compare and determine which input to emit.

In the event of a cache miss (e.g., a particular piece of information is requested from a cache, and the cache is unable to fill the request), the original service functionality provided by component B 606, C 608 and D 610 will execute due to the duplication of input data by the duplication component 702. The output of component D 610 will furthermore be added to the cache (B, D) 704 by an implicit duplication and data flow mechanism not shown in this figure.

A type signature of each node's input and outputs determine how that node may connect to other nodes. For a cache location to be valid, when the output type and input type of two components connected together must match. Furthermore, all input and output edges of components, including join, duplication and reduction nodes, must be connected to other components For example, if a join-m node cannot receive m inputs, it is not a valid graph.

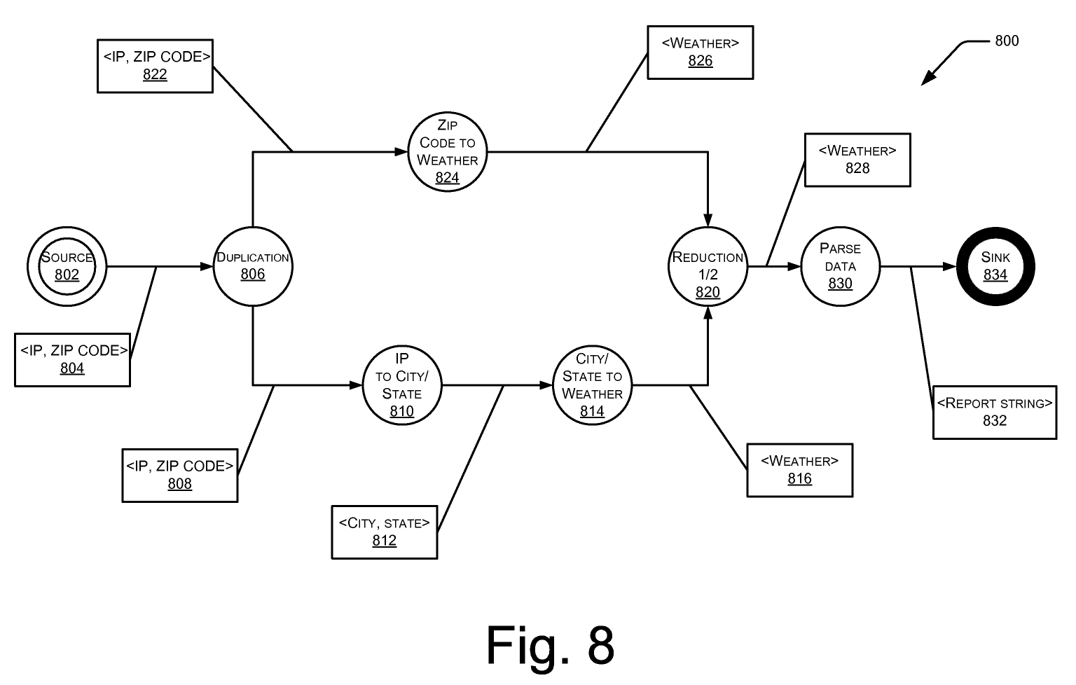

FIG. 8 is an illustrative service graph 800 depicting a flow of data through the service graph, which returns a weather forecast based on a zip code input. A source 802 emits data containing an internet protocol (IP) address and a zip code 808 to duplication element 806. Duplication element 806 emits data 808 containing the IP address and zip code to component 810. Component 810 translates an IP address to a city and state, and emits city and state data 812 to component 814. Component 814 looks up the weather based on city and state data 812, and emits weather information 816 to reduction component 820.

Returning to duplication element 806, duplication element 806 also emits data containing the IP address and zip code 822 to component 824. Component 824 looks up the weather based on zip code, and emits weather information 826 to reduction component 820.

Reduction component 820 determines an input to use, either weather information 826 or weather information 816. For example, if component 824 returns the weather information 826 to reduction component 820 before the edge traversing components 810 and 814, then reduction 820 may emit that information (i.e., the first information received). Alternatively, if the weather information 826 is determined to be stale, it may be discarded and reduction component 820 may utilize weather information 816 emitted by component 814 (i.e., the most up to date information may be used). Reduction component 820 emits weather 828 data to component 830, which parses the data. Parse data component 830 then emits a report string 832 to sink 834, including the requested weather information.

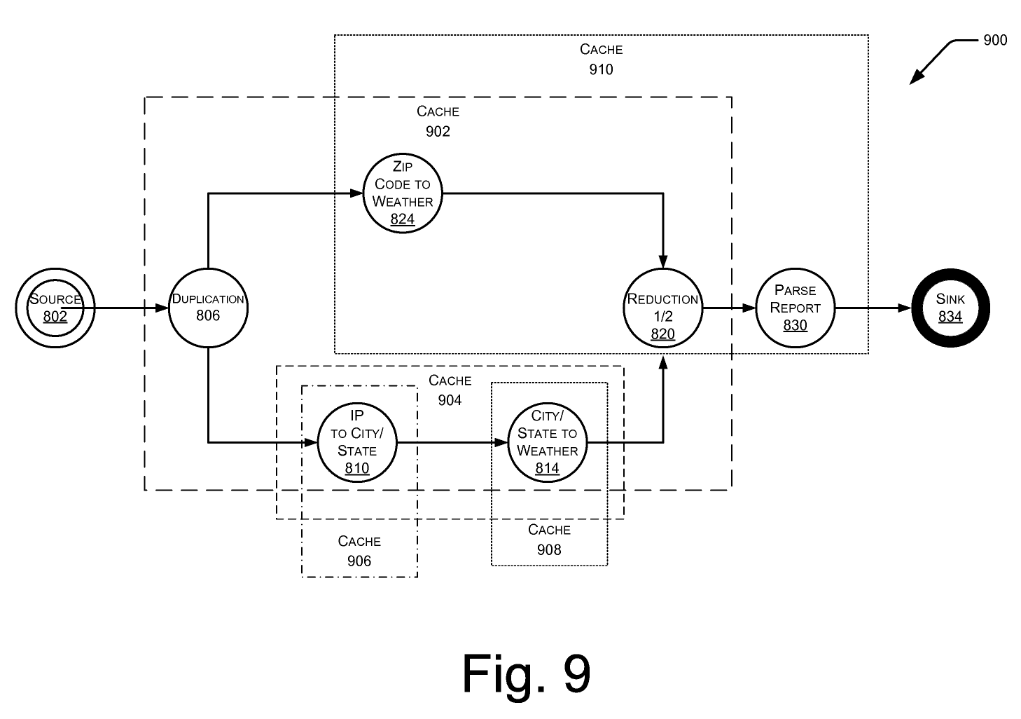

FIG. 9 is a diagram 900 depicting possible cache locations for the illustrative service graph of FIG. 8. A cache “wraps around” a sub-graph including one or more nodes of the graph. A cache may have a sub-graph comprising all components except the source 802 and sink 834, as indicated by cache 902. A cache 904 may have a sub-graph comprising components 810 and 814. A cache 906 may cache only component 810. A cache 908 may cache only component 814. A cache 910 may have a sub-graph comprising components 824, 820, and 830. Other variations are possible.

The service graph enables relatively simple construction and re-plumbing of a network service, including the addition of caching for sub-graphs. Determining what sub-graphs or individual components to cache may be aided by the optimization methods described next.

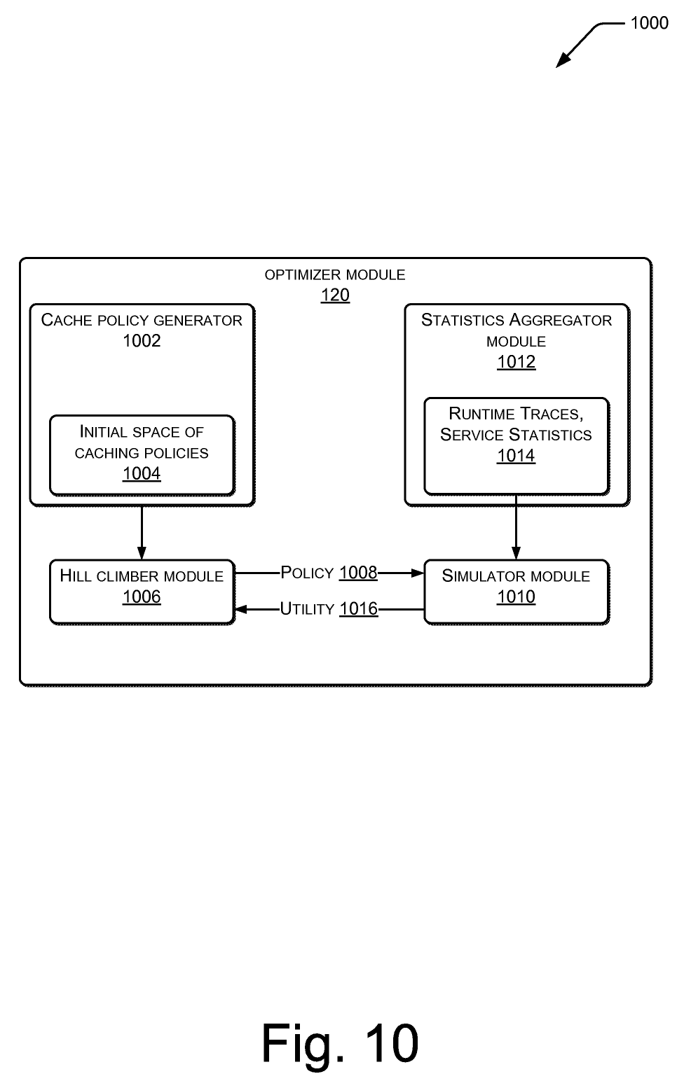

FIG. 10 is a diagram of an illustrative optimizer module 120. Optimizer module 120 contains a cache policy generator 1002. Cache policy generator 1002 is designed to create alternative cache policies for testing. An initial space of caching policies 1004 may be generated by cache policy generator 1002. Cache policies are sent to a hill climber module 1006 which sends a policy 1008 for testing to a simulator module 1010. A statistics aggregator module 1012 acquires runtime traces and service statistics 1014 from an internet or network runtime module (not shown here) and sends the runtime traces and service statistics 1014 to the simulator module 1010.

Simulator module 1010 tests the policy 1008 using runtime traces and service statistics 1014 to determine a utility value 1016, which is returned to the hill climber module 1006. The utility value may comprise a number of cache hits, resource costs, latency effects, assessment of complexity, assessment of reliability, etc. Higher utility values indicate a more useful result such as a cache which has a high number of hits, a lower response time after placement of a cache, a service graph having a minimum number of nodes, etc. A hill climber module 1006 utilizes this utility value and proceeds to use the hill climbing algorithm to determine a maximum utility value. Caching policies are iterated using the hill climber module to determine a policy which produces maximum utility from a space of tested policies.

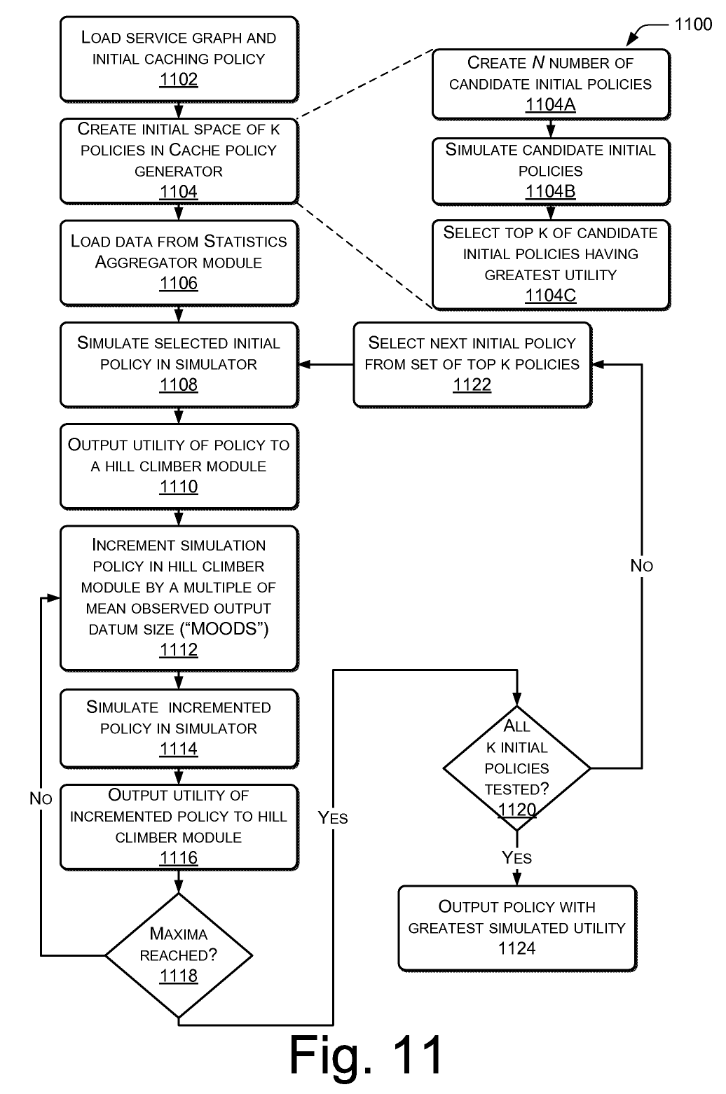

FIG. 11 is a flow diagram of operation of an illustrative optimizer module operation. At 1102, an optimizer module loads a service graph and an initial caching policy. At 1104, the optimizer module creates an initial set or space of k policies in a cache policy generator. This creation of an initial space of k policies may comprise, at 1104A, creating an N number of candidate initial policies. At 1104B, candidate initial policies may be simulated. And, at 1104C, a top k of initial candidate policies having greatest utility may be selected.

After the initial set of k policies is created 1104 in the cache policy generator from the top k of the N candidate initial policies, at 1106, data from a statistics aggregator module is loaded. At 1108, an initial policy is selected and simulated in a simulator module. At 1110, the simulator module outputs a utility of a policy under test to a hill climber module. At 1112, the hill climber module increments the policy being simulated by a multiple of a mean observed output datum size (MOODS). Examining an entire space of possible caching policies to determine one with greatest utility is computational intensive, particularly as the size of the service graph grows. Accordingly, rather than generating every possible cache value as a policy to simulate, cache values and their resulting policies may be incremented in steps determined by the MOODS.

The assumption underlying use of the MOODS is that the difference between allocation B bytes to a cache and B+1 bytes to a cache is likely to be negligible unless the values stored in the cache are very small. Hence, the cache policy generator may be configured to generate policies using multiples of the MOODS. As the hill climber module progresses, successor states are generated for simulation. For example, one method of generating a successor state is, for each pair of cache locations, to modify the original state by adding a MOODS of bytes to the first cache and removing the same number of bytes from the second cache.

At 1114, the incremented policy is simulated in the simulator. At 1116, the simulator outputs the utility of the incremented policy to the hill climber module. As described above, a cache may be added to a service graph during generation of policies for simulation. Similarly, caches may be evicted when their utility is below a specified threshold, or when other cache eviction policies such as a least-frequently used policy are met. In a least-frequently used policy, caches with the lowest number of hits may be removed.

At 1118, a determination is made if a maxima of utility has been reached. If not, then the process returns to 1112 and increments the simulation policy in the hill climber module. Otherwise, once a maxima for the policy has been reached at 1118, another determination is made, at 1120, whether all k initial policies have not been tested. If not, at 1122 the process proceeds to select the next initial policy from the set of top k policies and proceed to 1108 to simulate the selected initial policy in the simulator. Otherwise, if at 1120 all initial k policies have been tested, then at 1124, the process outputs the policy with the greatest simulated utility.

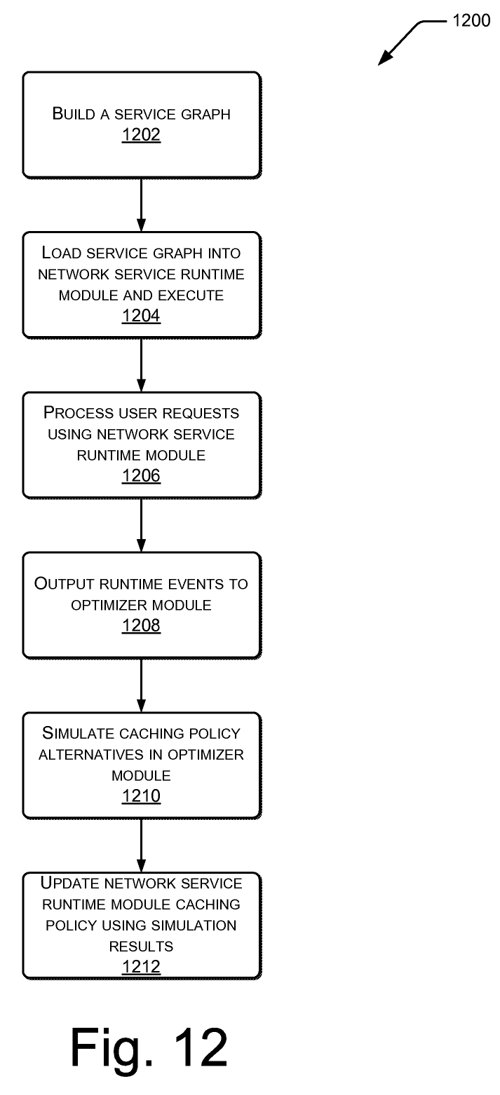

FIG. 12 is a flow diagram of an illustrative process 1200 of building and optimizing a service graph. At 1202, a service graph is built, either by a developer or an automated process. At 1204, the service graph is loaded into a network service runtime module and executed. A compiler may be used to generate a form of the service graph configured for execution on a processor. The compiler may incorporate infrastructure-specific information during compilation, and make user guided or autonomous compile-time decisions based on the infrastructure-specific information. Infrastructure-specific information may comprise the processor and other hardware present on an executing server, network link capacity, performance, reliability, storage cost, etc. For example, if dedicated cryptographic hardware is available on a server, during compilation the compiler may choose to utilize that dedicated cryptographic hardware to execute cryptographic functions found in the service graph, rather than execute them on the central processor of the server.

At 1206, user requests are processed using the network service runtime module. At 1208, runtime events are output to an optimizer module. At 1210, the optimizer module simulates caching policy alternatives, as described below, to develop an optimized caching policy. At 1212, the network service runtime module is updated to use the optimized caching policy.

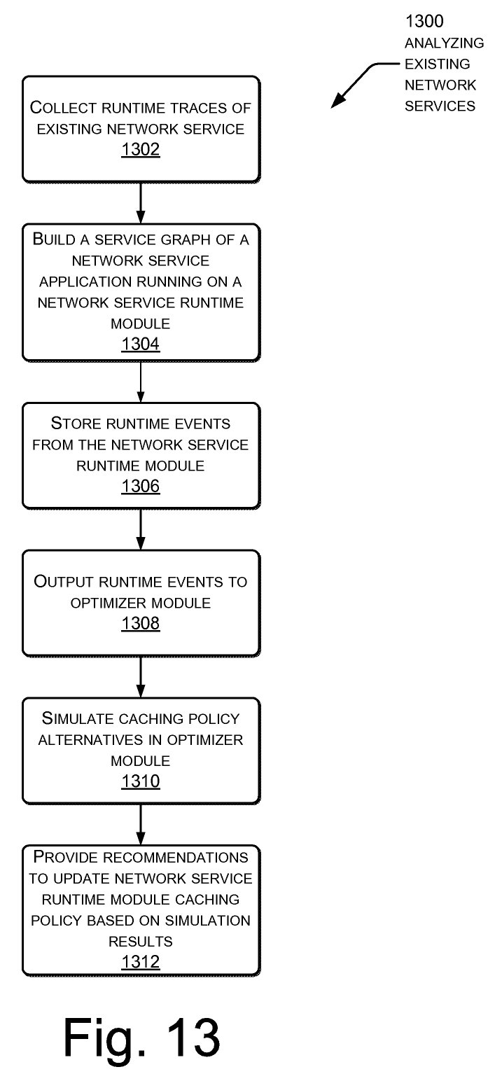

FIG. 13 is a flow diagram of an illustrative process 1300 of analyzing an existing network service, building a service graph, and providing optimization recommendations. Existing network service applications, which were either not built using a service graph, or for which a service graph is not otherwise available, may still benefit from optimization. At 1302, runtime traces of an existing network service application executing on a network service runtime module are collected. At 1304, the network services are analyzed to build a service graph of the network service application. As described above, a compiler may be used to generate a form of the service graph configured for execution on a processor, and the compiler may incorporate infrastructure-specific information during compilation to make user guided or autonomous compile-time decisions based on the infrastructure-specific information. At 1306, runtime events from the network service runtime module are stored. At 1308, runtime events are output to an optimizer module. At 1310, the optimizer module simulates caching policy alternatives, as described previously. At 1312, recommendations are provided of how to update the network service runtime module caching policy based on simulation results.

As described in this application, modules may be implemented using software, hardware, firmware, or a combination of these. In the illustrated examples, the modules are implemented using software including instructions stored on a computer-readable storage medium or otherwise in memory and executable on a processor.

Although specific details of exemplary methods are described with regard to the figures and other flow diagrams presented herein, it should be understood that certain acts shown in the figures need not be performed in the order described, and may be modified, and/or may be omitted entirely, depending on the circumstances. Moreover, the acts and methods described may be implemented by a computer, processor or other computing device based on instructions stored on one or more computer-readable storage media. The computer-readable storage media (CRSM) may be any available physical media that can be accessed by a computing device to implement the instructions stored thereon. CRSM may include, but is not limited to, random access memory (RAM), read only memory (ROM), electrically erasable programmable read only memory (EEPROM), flash memory or other memory technology, compact disc read only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by a computing device.

1. A method of developing and maintaining a high performance network service, the method comprising:
building a service graph comprising a dataflow representation of a responsive low-latency network service;
executing the service graph in a runtime module on a processor;
capturing and storing runtime event data from the runtime module;
analyzing the runtime event data; and
modifying the service graph.

2. The method of claim 1, wherein the modifying comprises simulating performance of a possible service graph using runtime event data.

3. The method of claim 1, wherein the modifying comprises maximizing utility.

4. The method of claim 1, wherein the runtime event data includes component-level input and output parameters and data.

5. The method of claim 1, wherein the service graph is built using runtime traces.

6. The method of claim 1, wherein the enhanced service graph is presented to a user.

7. The method of claim 1, wherein the analysis and optimization comprises placement of a cache around a node represented in the service graph.

8. The method of claim 7, further comprising autonomously analyzing and modifying the placement of a cache around one or more nodes in the service graph, the analyzing and modifying comprising:
storing runtime events from the execution of the network service in a statistics aggregator module;
analyzing the stored runtime events in an optimizer module, the analyzing comprising:
loading the service graph into the optimizer module;
creating an initial space of k initial sample policies based on the service graph, the creating comprising:
building an N number of candidate initial policies;
simulating the candidate initial policies using the stored runtime events as input to determine a utility of each candidate initial policy; and
selecting the k candidate initial policies having the largest utility values;
loading data from the statistics aggregator module into the optimizer module;
selecting and simulating a sample policy taken from the initial space of k sample policies;
assessing the simulation output of the sample policy using a hill climber module, the assessing comprising;
updating the sample policy in the hill climber module;
simulating the updated sample policy and outputting the results back to the hill climbing module; and
iterating and updating the sample policy until a maxima is reached by the hill climber module;
simulating and iterating a next sample policy using the hill climber module, the next sample policy taken from untested policies in the initial space of k sample policies; and
comparing the maxima produced by the hill climber module from the simulated sample policies to determine which simulated policy has maximum utility of all policies simulated.

9. The method of claim 8, further comprising executing the simulated policy having the maximum utility of all policies simulated.

10. The method of claim 8, wherein building an N number of initial sample policies using a random policy input.

11. A method of autonomously analyzing a network service, the method comprising:
storing runtime events of a network service, the network service comprising components in an initial configuration with one another;
simulating alternative configurations of the network service using the stored runtime events to determine a utility value of each of the alternative configurations; and
determining an alternative configuration having maximum utility based on the simulating.

12. The method of claim 11, wherein simulating alternative configurations of the network service comprises introducing a cache component or a pre-processing component or a parallel component into the alternative configuration.

13. The method of claim 11, wherein simulating alternative configurations of the network service comprises:
building a number N of candidate initial configurations;
simulating each initial candidate configuration using the stored runtime events as input to determine a utility of each initial candidate configuration; and
selecting an initial candidate configuration having a greatest utility value.

14. The method of claim 11, further comprising implementing the alternative configuration having maximum utility.

15. The method of claim 11, wherein determining the alternative configuration using a hill climbing module to test the alternative configurations and determine which alternative configuration provides the maximum utility.

16. The method of claim 11, wherein an alternative configuration comprises a cache.

17. The method of claim 11, wherein the alternative configurations are generated using a randomization of the initial configuration, the randomization comprising introducing new elements, or reorganizing elements, or grouping elements, or removing elements, or a combination thereof.

18. The method of claim 11, wherein simulating alternative configurations of the network service comprises:
simulating an initial sample configuration taken from an initial space of k sample policies and storing a resulting utility value;
updating a parameter in the initial sample configuration using a hill climbing module to create an incremented sample configuration;
simulating the updated sample configuration and outputting the results to the hill climbing module; and
updating the sample configuration in the hill climbing module until a maximum utility value is reached.

19. The method of claim 14, wherein implementing the alternative configuration having maximum utility occurs during execution of the network service.

20. A method comprising:
storing historical usage data of a network service, the network service comprising components in an initial configuration;
creating alternative configurations of the network service;
executing the alternative configurations of the network service in a simulator using the stored historical usage data as input; and
storing performance information of each executed alternative configuration.

21. The method of claim 20, further comprising determining a configuration of the alternative configurations having maximum utility.

22. The method of claim 21, further comprising implementing the alternative configuration having maximum utility.

23. An infrastructure-independent method of developing a high performance network service, the method comprising:
building a service graph representing a responsive network service;
compiling the service graph in a compiler into a form configured for execution on a processor;
executing the service graph in a runtime module on a processor;
capturing and storing runtime event data from the runtime module;
analyzing the runtime event data to generate analysis results; and
modifying the service graph based on the analysis results.

24. The method of claim 23, wherein the compiler incorporates infrastructure-specific information into autonomous compile-time decisions.
